(19) United States
(12) Patent Application Publication
(10) Pub. No.: US 2023/0363329 A1
(43) Pub. Date: Nov. 16, 2023

(54) TREE MAT FOR WATERING AND FERTILIZER APPLICATION

(71) Applicant: VORIM INC., Seoul (KR)

(72) Inventor: Do Hoon KIM, Seoul (KR)

(21) Appl. No.: 18/196,054

(22) Filed: May 11, 2023

(30) Foreign Application Priority Data
May 16, 2022 (KR) 10-2022-0059666

(51) Int. Cl. A01G 13/02

(52) U.S. Cl. CPC A01G 13/0268; A01G 13/0281

(57) ABSTRACT

A tree mat is formed to cover the root portion of a planted tree and cover the surrounding soil. The tree mat according to an embodiment includes a base part formed in a predetermined size to cover soil around a tree and including a tree insert hole formed in a central portion thereof, and a protective part provided in the same shape including the tree insert hole as the base part and coupled to an upper portion of the base part to store fertilizer or water between the base part and the protective part, wherein the base part includes fine water supply/drain holes formed therein to have a predetermined size so that the fertilizer is discharged to the soil.

### CROSS-REFERENCE TO RELATED APPLICATION AND CLAIM OF PRIORITY

This application claims the benefit under 35 USC § 119 of Korean Patent Application No.10-2022-0059666, filed on May 16, 2022, in the Korean Intellectual Property Office, the entire disclosure of which is incorporated herein by reference for all purposes.

### BACKGROUND

### 1. Field of the Invention

The present invention relates to a tree mat for watering and fertilizer application, which is formed to cover a root portion of a tree and surrounding soil, and more particularly, to a tree mat for watering and applying fertilizer to the tree, in which a water inlet port and fine water supply/drain holes are formed in a cover having an inner storage space for filling fertilizer and wrapping the filled contents, such that fertilizer application according to absorption and drainage of rainwater as well as water injection are possible, and thereby the survival rate of trees may be improved.

### 2. Description of the Related Art

Loss of valuable forest resources due to large-scale forest fires which are repeated every year is also a big problem. However, even if a restoration work is performed through a large-scale afforestation project in forest fire burned areas, dead trees are appearing one after another because irrigation and fertilization are difficult due to field conditions. In particular, since adhesion of trees to the soil is deteriorated due to the forest fire, the risk of landslides due to localized heavy rains is high. Therefore, a protective device capable of supplying water and nutrients to help the tree quickly takes root, and protecting against trauma, frost damage, and soil loss is required.

For example, the protective device may be formed to cover soil around the root portion of the planted tree in order to protect the root portion of the tree. If the protection device is not installed, the soil loss causes great damage, and weeds grow thickly around the root portion, thereby interfering with the growth of the tree. For this reason, mowing projects are performed several times in afforestation areas, but afforestation trees are mowed down with a blade of a brush cutter or withered due to injury, and there is a serious shortage of manpower.

Due to these problems, there is an urgent need to develop a protective device capable of physically protecting the trunk from the sharp blade of the brush cutter while covering the soil around the root portion of the tree.

In addition, in the case of public trees and street trees in urban areas, water bags for irrigation or nutrient solution are hung or inserted into the trees as a part of maintenance project. In this case, not only the appearance of the street may be deteriorated, but also holes should be drilled in the tree to directly supply moisture and nutrients to the xylem and cambium of the tree. Due to this form, the trees may be damaged and a penetration pathway of diseases and insect pests may be provided, thereby adversely affecting the growth of the trees.

### SUMMARY

An object of the present invention is to provide a tree mat for watering and fertilizer application, which may be formed to cover a root portion of a tree and surrounding soil thus to prevent freezing damage caused by cold waves in winter and salt damage caused by deicing agents, and may prevent weeds from growing around the tree to preserve growth environments of the tree.

In addition, another object of the present invention is to provide a tree mat for watering and fertilizer application, in which a water inlet port and fine water supply/drain holes are formed in a cover having an inner storage space for filling fertilizer and wrapping the filled contents, such that fertilizer application according to absorption and drainage of rainwater as well as water injection are possible, and thereby the survival rate of trees may be improved.

To achieve the above objects, according to an aspect of the present invention, there is provided a tree mat including: a base part formed in a predetermined size to cover soil around a tree and including a tree insert hole formed in a central portion thereof; and a protective part provided in the same shape including the tree insert hole as the base part and coupled to an upper portion of the base part to store fertilizer or water between the base part and the protective part, wherein the base part includes fine water supply/drain holes formed therein to have a predetermined size so that the fertilizer is discharged to the soil.

In addition, the base part and the protective part may include: a plurality of cut portions radially cut from the tree insert holes; and inlet grooves cut from the tree insert holes to ends of the base part and the protective part, and formed to guide a trunk of the tree into the tree insert holes.

Further, diameters of the tree insert holes may be formed smaller than or equal to a diameter of tree so that portions of the base part and the protective part located around the cut portions are erected to cover a soil contact portion of the tree, when the tree insert holes are positioned on an outer circumference of the trunk of the tree.

Further, the fine water supply/drain holes may be formed in a micrometer (pm) size.

Further, the base part and the protective part may be made of a biodegradable material including at least one of corn and sugarcane, thus to be used as compost upon biodegradation.

Further, the protective part may include a water inlet port formed therein to supply water between the base part and the protective part.

Furthermore, the base part and the protective part may include a mixture of a filler, a flame retardant and a UV stabilizer, and the filler includes at least one of humus, peat moss, sericite, zeolite, a soil microbial agent and a wetting agent.

Further, the mixture may be mixed with water and applied to surfaces of the base part and the protective part after the base part and the protective part are manufactured and installed in the field.

According to the present invention, as the tree mat is formed to cover the root portion of the tree and surrounding soil using the base part and the protective part filled with fertilizer components and water, it is possible to prevent the soil or product from being lost due to rain, wind, etc. not only in forest areas but also in urban areas, and preserve growth environments of the tree by reducing the trampling damage caused by pedestrians.

In addition, since the root portion of the tree and the surrounding soil are covered by the base part and the protective part, watering function may be expected during the drying season, and salt damage caused by freezing and deicing agents may be effectively prevented during the winter.

Further, the inner storage space between the base part and the protective part is filled with fertilizer and water, and fine water supply/drain holes are formed in the base part and the protective part, such that fertilizer application according to the absorption and drainage of water or rainwater is possible, and thereby increasing the survival rate of the trees.

Further, since a sufficient amount of fertilizer and water are filled between the base part and the protective part, the fertilizer and water are slowly released over several years, and no separate work to fix the tree mat to the ground is required, and no maintenance is required, thereby reducing labor costs.

Furthermore, since the base part and the protective part are made of a biodegradable material including at least one of corn and sugarcane, the base part and the protective part are gradually biodegraded and turned into compost after a certain period of time is elapsed. Therefore, the tree mat of the present invention is eco-friendly and does not require dismantling of the product, such that maintenance costs may be reduced.

Moreover, since the base part and the protective part contain components having flame retardancy, it is possible to delay and prevent the trees from being swept with fire.

Furthermore, since the soil around the root portion of the tree is covered by the base part and the protective part, it is possible to prevent weeds from growing around the tree. As a result, damage caused by the weeds may be prevented, and the mowing work is not required to reduce labor costs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a tree mat according to an embodiment of the present invention;

FIG. 2 is an exploded perspective view of the tree mat shown in FIG. 1;

FIG. 3 is an enlarged view illustrating a portion of the base part of the tree mat shown in FIG. 1;

FIG. 4 is a cross-sectional view illustrating a state in which fertilizer is stored inside the tree mat shown in FIG. 1;

FIG. 5 is a view illustrating an example of using the tree mat shown in FIG. 1; and

FIG. 6 is a cross-sectional view illustrating a state in which water is stored inside the tree mat shown in FIG. 1.

### DETAILED DESCRIPTION OF THE INVENTION

Hereinafter, a tree mat according to a preferred embodiment will be described in detail with reference to the accompanying drawings. Here, same reference numerals will be denoted to the same configurations, and the publicly known functions and configurations that are judged to be able to make the purport of the present invention unnecessarily obscure will not be repeatedly described in detail. Such embodiments are provided for completely describing the present invention to persons having ordinary knowledge and skills in the related art. Therefore, shapes and sizes of elements in the drawings may be exaggerated for clearer description.

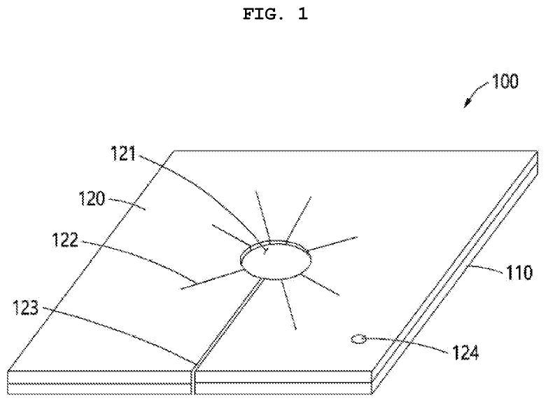

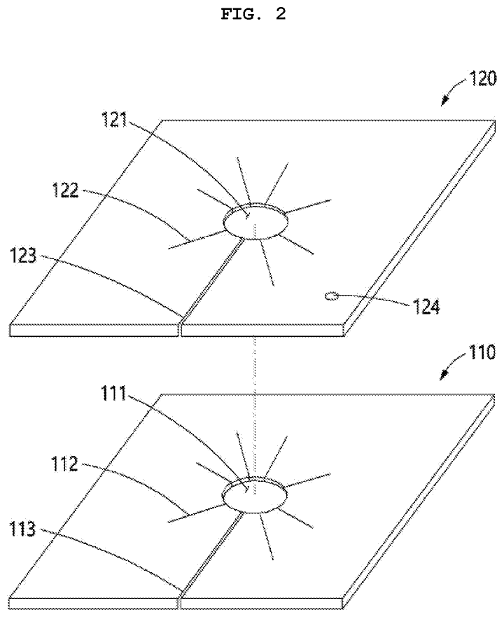

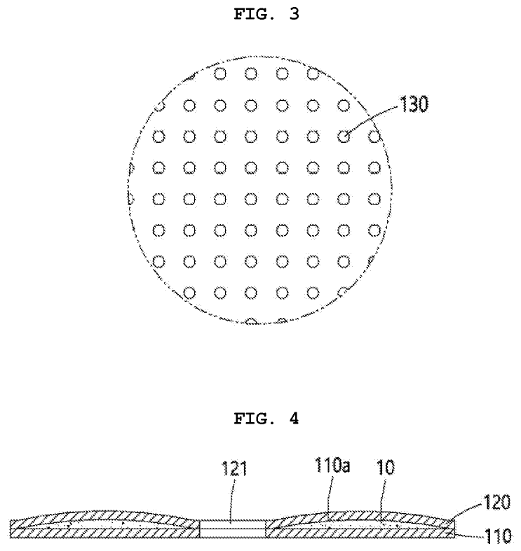

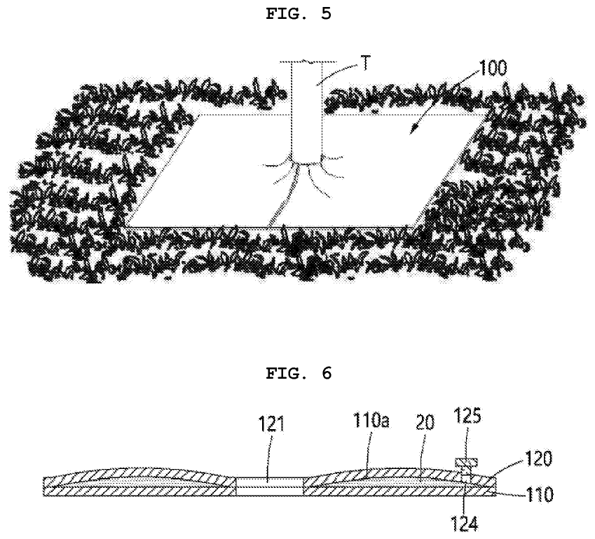

FIG. 1 is a perspective view of a tree mat according to an embodiment of the present invention, FIG. 2 is an exploded perspective view of the tree mat shown in FIG. 1, FIG. 3 is an enlarged view illustrating a portion of the base part of the tree mat shown in FIG. 1, FIG. 4 is a cross-sectional view illustrating a state in which fertilizer is stored inside the tree mat shown in FIG. 1, and FIG. 5 is a view illustrating an example of using the tree mat shown in FIG. 1.

Referring to FIGS. 1 to 5, a tree mat 100 of the present invention is formed to wrap a root portion of a planted tree T and cover surrounding soil to protect the root portion of the tree T, and may include a base part 110 and a protective part 120.

The base part 110 is formed in a predetermined size to cover soil around the tree T, and may include a tree insert hole 111 formed in a central portion thereof. For example, the base part 110 may be formed in a rectangular plate shape in which the circular tree insert hole 111 is formed in the central portion thereof.

The protective part 120 is provided in the same shape including the circular tree insert hole as the base part 110 and may be coupled to an upper portion of the base part 110 to store fertilizer 10 between the base part 110 and the protective part 120. For example, edges of the protective part 120 may be coupled to edges of the base part 110 through a method such as adhesion or stitching. Due to such coupling, a storage space 110a is formed between the base part 110 and the protective part 120 in an envelope shape, and the fertilizer 10 may be stored in the storage space 110a. At this time, although not shown in the drawings, by providing a zipper in the base part 110 or the protective part 120, the storage space 110a may be formed so that the fertilizer 10 is easily filled or replenished.

The base part 110 may include fine water supply/drain holes 130 formed therein to have a predetermined size so that the fertilizer 10 may be discharged to the soil. Here, the fine water supply/drain holes 130 allow the fertilizer 10 filled in the storage space 110a to be discharged naturally. In the present embodiment, the case in which the fine water supply/drain holes 130 are formed only in the base part 110 is illustrated, but it is also possible to form the water supply/drain holes in both the base part 110 and the protective part 120.

Accordingly, rainwater flows into the storage space 110a through the fine water supply/drain holes 130 and is mixed with the fertilizer 10, then the rainwater mixed with the fertilizer 10 in this way may be discharged through the fine water supply/drain holes 130 to the soil. At this time, the fine water supply/drain holes 130 may be formed in a micrometer (μm) size so that the fertilizer 10 is not normally discharged and may be discharged only when it rains.

In this way, as the fine water supply/drain holes 130 are formed in the base part 110, a fertilizer application function according to absorption and drainage of the rainwater is possible, such that the survival rate of the tree T may be improved. In addition, since the fertilizer 10 is filled between the base part 110 and the protective part 120, a separate process for fixing the tree mat 100 to the ground is not required. That is, due to the weight of the filled fertilizer 10, the mat is not blown away by the wind even without a process such as mulching, and thereby facilitating the process of installing the mat.

According to the present invention, the base part 110 and the protective part 120 may include a plurality of cut portions 112 and 122 radially cut from the tree insert holes 111 and 121, and inlet grooves 113 and 123 cut from the tree insert holes 111 and 121 to ends of the base part 110 and the protective part 120, and formed to guide the trunk of the tree into the tree insert holes 111 and 121.

In this way, as the radial cut portions 112 and 122 are formed in the base part 110 and the protective part 120, the tree mat may be used for all trees T regardless of diameters of the trees T. That is, since the diameters of the tree insert holes 111 and 121 may be expanded while the cut portions 112 and 122 are extended according to the diameter of the tree T, the tree mat may be correspondingly used regardless of the type and age of the tree T. In addition, after the tree mat 100 is installed on a young small tree, even when the small tree reaches a large tree, the tree mat 100 may be continuously used without change due to the expansion of the tree insert holes 111 and 121 through the extendable cut portions 112 and 122.

In addition, since the tree T may be introduced into the tree insert holes 111 and 121 through the inlet grooves 113 and 123, the tree mat may be easily installed.

Meanwhile, diameters of the tree insert holes 111 and 121 are formed smaller than or equal to a diameter of tree T, and lengths of the radial cut portions 112 and 122 may be formed larger than the diameter of tree T so that portions of the base part 110 and the protective part 120 located around the cut portions 112 and 122 are erected to cover a soil contact portion of the tree (see FIG. 5), when the tree insert holes 111 and 121 are positioned on an outer circumference of the trunk of the tree. In this way, since the soil contact portion of the tree T may be covered by the base part 110 and the protective part 120, it is possible to prevent the soil contact portion from being damaged by the blade of a brush cutter or animals.

In addition, the erected portions of the base part 110 and the protective part 120 are bonded through thermal bonding without filling with fertilizer or water, thereby strengthening the bonding strength of the erected portions to further more safely protect the soil contact portion of the tree T.

According to the present invention, the base part 110 and the protective part 120 may be made of biodegradable pulp or nonwoven material. For example, the biodegradable pulp may include at least one of corn and sugar cane, thus to be used as compost upon biodegradation. In this case, after a certain period of time is elapsed, the base part 110 and the protective part 120 are gradually biodegraded and turned into compost. Therefore, the tree mat of the present invention is eco-friendly, and maintenance costs may be reduced because it does not require removal of the product.

Meanwhile, when the base part 110 and the protective part 120 are made of a non-woven fabric material, a separate operation for perforating the fine water supply/drain holes 130 is not required due to the nature of the non-woven fabric material, and salt damage caused by freezing and deicing agents in winter may be effectively prevented. Here, the non-woven fabric refers to a planar structure made by mechanically or physically combining fibers to form a sheet-shaped web, and an industrial non-woven fabric may be illustrated as an example.

FIG. 6 is a cross-sectional view illustrating a state in which water is stored inside the tree mat shown in FIG. 1.

As shown in FIG. 6, water 20 may be stored instead of fertilizer 10 in the storage space 110a between the base part 110 and the protective part 120. In this way, when the water 20 is stored in the storage space 110a, moisture may be gradually supplied to the tree T through the fine water supply/drain holes 130, such that drought may be effectively prepared. At this time, a water inlet port 124 may be formed in the protective part 120 to supply water between the base part 110 and the protective part 120, and the water inlet port 124 may be opened and closed by an opening/closing member 125.

According to the present invention, the base part 110 and the protective part 120 may be provided to have flame retardancy and UV stability. For example, the base part 110 and the protective part 120 may include a mixture of a filler, a flame retardant and a UV stabilizer, and the filler may include at least one of humus, peat moss, sericite, zeolite, a soil microbial agent and a wetting agent. Specifically, the mixture may be mixed with water and applied to surfaces of the base part 110 and the protective part 120 after the base part 110 and the protective part 120 are manufactured and installed in the field. That is, after manufacturing of the base part 110 and the protective part 120 is completed, the surfaces of the base part 110 and the protective part 120 may be coated with the mixture by a method of spraying a liquid mixture on the surfaces of the base part 110 and the protective part 120 using a spray nozzle or the like, or immersing the base part 110 and the protective part 120 in the liquid mixture. At this time, the mixture may further include a small amount of pesticide as a pest control and repellent.

In this way, since the base part 110 and the protective part 120 are formed to have flame retardancy, it is possible to delay and prevent the tree T from being swept with forest fire. In addition, since the base part 110 and the protective part 120 are formed to have UV stability, the base part 110 and the protective part 120 are prevented from being damaged by strong ultraviolet rays, such that the function of the tree mat 100 may be maintained for a long period of time.

As described above, since the tree mat is formed to cover the root portion of the tree T and the surrounding soil using the base part 110 and the protective part 120, it is possible to prevent the soil or product from being lost due to rain, wind, etc. not only in forest areas but also in urban areas, and preserve the growth environments of the tree T by reducing the trampling damage caused by pedestrians.

In addition, since the root portion of the tree T and the surrounding soil are covered by the base part 110 and the protective part 120, watering function may be expected during the drying season, and salt damage caused by freezing and deicing agents may be effectively prevented in winter.

Further, the storage space 110a between the base part 110 and the protective part 120 is filled with the fertilizer 10 and water, and the fine water supply/drain holes 130 are formed in the base part 110 and the protective part 120, such that fertilizer application according to the absorption and drainage of water or rainwater is possible, and thereby increasing the survival rate of the tree T.

Further, since a sufficient amount of fertilizer and water are filled between the base part 110 and the protective part 120, the fertilizer and water are slowly released over several years, and no separate work to fix the tree mat to the ground is required, and no maintenance is required, thereby reducing labor costs.

Furthermore, since the base part 110 and the protective part 120 are made of a biodegradable material including at least one of corn and sugarcane, the base part 110 and the protective part 120 are gradually biodegraded and turned into compost after a certain period of time is elapsed. Therefore, the tree mat is eco-friendly and does not require dismantling of the product, such that maintenance costs may be reduced.

Moreover, since the base part 110 and the protective part 120 contain components having flame retardancy, it is possible to delay and prevent the trees from being swept with fire.

Furthermore, since the soil around the root portion of the tree is covered by the base part 110 and the protective part 120, it is possible to prevent weeds from growing around the tree. As a result, damage caused by the weeds may be prevented, and the mowing work is not required to reduce labor costs.

Although the present invention has been described with reference to the embodiments shown in the drawings, these are merely an example. It should be understood by persons having common knowledge in the technical field to which the present invention pertains that various modifications of the embodiments may be made, and such modifications are included in the technical protection scope of the present invention. Accordingly, the real technical protection scope of the present invention is determined by the technical idea of the appended claims.

What is claimed is:

1. A tree mat comprising:
a base part formed in a predetermined size to cover soil around a tree and including a tree insert hole formed in a central portion thereof; and
a protective part provided in the same shape including the tree insert hole as the base part and coupled to an upper portion of the base part to store fertilizer or water between the base part and the protective part,
wherein the base part includes fine water supply/drain holes formed therein to have a predetermined size so that the fertilizer is discharged to the soil.

2. The tree mat according to claim 1, wherein the base part and the protective part include: a plurality of cut portions radially cut from the tree insert holes; and inlet grooves cut from the tree insert holes to ends of the base part and the protective part, and formed to guide a trunk of the tree into the tree insert holes.

3. The tree mat according to claim 2, wherein diameters of the tree insert holes are formed smaller than or equal to a diameter of tree so that portions of the base part and the protective part located around the cut portions are erected to cover a soil contact portion of the tree, when the tree insert holes are positioned on an outer circumference of the trunk of the tree.

4. The tree mat according to claim 1, wherein the fine water supply/drain holes are formed in a micrometer (μm) size.

5. The tree mat according to claim 1, wherein the base part and the protective part are made of a biodegradable material including at least one of corn and sugarcane, thus to be used as compost upon biodegradation.

6. The tree mat according to claim 1, wherein the protective part includes a water inlet port formed therein to supply water between the base part and the protective part.

7. The tree mat according to claim 1, wherein the base part and the protective part include a mixture of a filler, a flame retardant and a UV stabilizer, and the filler includes at least one of humus, peat moss, sericite, zeolite, a soil microbial agent and a wetting agent.
